(19) United States
(12) Patent Application Publication
(10) Pub. No.: US 2011/0260814 A1
(43) Pub. Date: Oct. 27, 2011

(54) CONTINUOUSLY WOUND SOLENOID COIL WITH FINAL CORRECTION FOR GENERATING A HOMOGENEOUS MAGNETIC FIELD IN THE INTERIOR OF THE COIL AND ASSOCIATED OPTIMIZATION METHOD

(75) Inventors: Andrea Raccanelli, Bonn (DE); Rolf Krause, Lugano (CH)

(73) Assignees: RHEINISCHE FRIEDRICH-WILHELMS-UNIVERSITÄT BONN, Bonn (DE); FORSCHUNGSZENTRUM JÜLICH GMBH, Juelich (DE)

(21) Appl. No.: 12/998,710

(22) PCT Filed: Nov. 30, 2009
(86) PCT No.: PCT/DE2009/001674

§ 371 Date: Jul. 18, 2011

(30) Foreign Application Priority Data
Dec. 15, 2008 (DE) 10 2008 060 757.6

(51) Int. Cl. H01F 7/06

(52) U.S. Cl. 335/209

(57) ABSTRACT

Disclosed is a device for generating a uniform magnetic field and to an optimization method for magnetic fields in a sample space, the method providing specifications for producing such a device. The device comprises at least one field coil for generating the magnetic field and the turns of the field coil are continuously wound around the sample space and the turn diameter of the field coil changes continuously at least in a portion of the field coil along the longitudinal axis of the sample space. To this end, the correction of non-uniformities in the magnetic field caused by the finite length of the field coil is distributed over the entire field coil. In this way, the device can be implemented more easily and precisely than with the correction coils used according to the prior art for correcting non-uniformities. Instead of the existing series expansion of the magnetic field, the method for optimizing the magnetic field employs a power function in conjunction with simulation of the magnetic field based on the optimization parameters. This function can be used in a larger volume than the series expansion.

The invention relates to a device for generating a uniform magnetic field and to an optimization method for magnetic fields in a sample space that provides specifications for producing such a device.

### STATE OF THE ART

Many applications, for example in magnetic resonance imaging, require the application of a uniform magnetic field to an oblong sample space. To this end, generally oblong solenoid coils are used, which are wound around the sample space. The magnetic field in the interior of such a coil, however, is only exactly uniform in the limit case where the coil is infinitely long. With coils having finite length in real applications, in contrast, the uniformity is impaired by boundary effects.

Correction coils that counteract the undesirable deviations from perfect uniformity are used to compensate for these boundary effects. The disadvantage is that these correction coils require additional installation space and additional power leads, which are not always available, particularly in the confined interior of a cryostat. Moreover, the desired uniformity of the magnetic field can only be achieved if the sizes and positions of the correction coils calculated in advance are precisely adhered to in the material production of the magnet assembly. The precision requirements, which may be in the submicrometer range, at times exceed the manufacturing tolerances.

To avoid additional power leads and the heating caused by such additional power leads, the separately actuatable correction coils have sometimes been implemented as additional correction windings that are integrated in the solenoid coil, which always conduct the same current as the solenoid coil. The disadvantage is that the precision requirements for positioning the correction windings are even greater than the precision requirements for positioning the separately actuatable correction coils.

### PROBLEM AND SOLUTION

It is therefore the object of the invention to provide a device for generating a magnetic field that applies a more uniform field to a sample space, even without correction coils or correction turns, than a solenoid coil and that can be produced with lower mechanical precision requirements than the requirements when using correction coils or correction turns according to the prior art.

These objects are achieved according to the invention by a device according to the main claim and by an optimization method according to the additional independent claim. Further advantageous embodiments will be apparent from the dependent claims.

### SUBJECT MATTER OF THE INVENTION

Within the scope of the invention, a device for generating a uniform magnetic field in an oblong sample space was developed. The device comprises at least one field coil for generating the magnetic field.

Uniformity shall not be understood here in the mathematical sense as a yes-no characteristic but as a gradual term, which embodies the remaining deviation of the actual state from this mathematical ideal state that physically cannot be achieved. It can be defined, in absolute terms, as the maximum difference between the actual state and the ideal state in units of the magnetic field (“uniformity down to x millitesla”). However, it can also be defined in relative terms as a (value-based or quadratic) quotient ΔB/B of this deviation and the magnetic field intensity (“uniformity down to 10⁻⁴”).

According to the invention, the field coil is continuously wound around the sample space, and the turn diameter thereof changes continuously in at least a portion of the field coil along the longitudinal axis of the sample space.

It was found that such a configuration of the field coil can considerably reduce boundary effects that occur with solenoid coils not having infinite length, which worsen the uniformity of the field, even if no additional correction coils or correction turns are present. According to the invention, in this way a partial correction of the non-uniformity of the magnetic field caused by the finite length of the field coil is already incorporated directly in the field coil. The magnetic field distribution in the interior of the sample space can thus be considerably more uniform, even without correction coils or correction turns, than when using a conventional cylindrical solenoid coil.

To this end, it is essential that the turn diameter of the field coil continuously changes along the longitudinal axis of the sample space. Because of the finite length of the coil, the magnetic field of the field coil is not uniform. The correction of this non-uniformity, which according to the prior art was achieved by few discrete correction coils or correction turns, is distributed to the entire field coil by the continuous change of the turn diameter. Each infinitesimal turn element contributes an infinitesimal part of the correction. The relationship between the required uniformity of the magnetic field in the interior of the sample space and the precise configuration of the field coil is thus continuous.

The person skilled in the art is faced with the problem of producing a device having a predefined overall size, which generates a magnetic field having a predefined field intensity and uniformity in a predefined partial volume of the sample space (“volume of interest”, VOI). Prepared with the teaching according to the invention, wherein the field coil should be wound continuously around the sample space and the turn diameter thereof should continuously change in at least a portion of the field coil along the longitudinal axis of the sample space, the person skilled in the art can tailor the exact configuration of the field coil using a suitable optimization method so that the specifications of the stated problem are met. For this, a broad range of methods are available to the person skilled in the art. For simple standard situations, commercial software is available for calculating the magnetic field distribution. As an alternative, or in combination therewith, a parameterized approach can be taken for the shape of the field coil. The free parameters can subsequently be optimized using standard software. The continuous dependence of the magnetic field properties on the exact configuration of the field coil allows for the use of modern techniques for both numerical simulation and parameter optimization. The invention further relates to a particularly suitable parameter optimization method, in which specific properties of the magnetic field are optimized. The optimization parameters are associated with the shape of the field coil. In order to evaluate a set of concrete values for the optimization parameters, the magnetic field distribution in the sample space resulting from these values is numerically simulated in each step of the optimization method. Optimization by means of numerical simulation is considerably faster when using the tools available today than the classic optimization based on the physical manufacture of prototypes and measurement of the respectively generated magnetic field. However, even this type of optimization would require a person skilled in the art to perform only a reasonable number of experiments to achieve uniformity of the magnetic field that is better than that of a cylindrical solenoid coil.

The good behavior of the magnetic field properties during optimization of the coil shape is owing the fact that distribution of the correction to the entire field coil means that less than optimal positioning of the turns impacts the uniformity of the magnetic field in the sample space far less severely than a mispositioning of the few discrete correction coils or correction turns used according to the prior art. According to the prior art, the magnetic field distribution in the sample space depended on the positions of the correction coils or correction turns with such great sensitivity that even a numerically ascertained optimum of these positions was not always physically possible to implement. The optimum was so narrow that the precision requirements at times exceeded manufacturing tolerances. According to the present findings of the inventors, the cause of this disadvantage of the prior art was that the entire effect of the correction hinged on just a few parameters, more specifically the positions and field intensities of the few discrete correction coils, or the positions of the correction turns. It was found that the effect of the correction of the magnetic field is more difficult to control with correction turns than with separate correction coils because, with correction turns, the current cannot be set separately. This is the reason why the precision required for positioning correction turns is even higher than for positioning correction coils.

According to the invention, the effect of the correction now depends on the positioning of each infinitesimal turn element, so that the correction can be regarded as a continuum. The effect of mispositionings of individual regions of turns on the magnetic field distribution is therefore notably so low that accidental fluctuations in the manufacturing process mutually average each other out.

The improved uniformity of the magnetic field in the sample space also means that the partial volume of the sample space in which the uniformity requirements predefined by the specific application are met (“volume of interest”, VOI) is greater than with the use of conventional solenoid coils.

The field coil, or the collectivity of all field coils, does not have to surround the entire sample space. The effect according to the invention is also achieved when gaps exist between several field coils along the longitudinal axis of the sample space, or even if an individual field coil contains gaps. Such gaps can keep the sample space accessible for observing or manipulating the sample located therein when a magnetic field is present.

In a particularly advantageous embodiment of the invention, the turn diameter in the field coil, or the collectivity of all field coils, increases strictly monotonically along at least 10%, preferably at least 20%, and particularly preferably at least 30% of the longitudinal axis of the sample space, and it decreases strictly monotonically along at least 10%, preferably at least 20%, and particularly preferably at least 30% of the longitudinal axis of the sample space. The correction of the non-uniformity of the magnetic field generated by the field coil is then distributed over such a large region along the longitudinal axis that minor mispositionings of individual turns do not negate the correction. The precision that can usually be achieved in machine winding of coils suffices.

In descriptive terms, this means the following: in general, the lines of flux in a solenoid coil are denser at the center of the coil, so that the magnetic field is stronger than at the ends of the coil. If the turn diameter increases as the center of the coil is increasingly approached, so that the diameter is at the maximum in particular at the center of the coil, the denser lines of flux are bent apart. In this way, the magnetic field is made uniform.

The field coil can be designed to be self-supporting; it is not absolutely imperative that it is wound on a carrier. In applications in nuclear physics, for example, it may be necessary to have the least amount of area density possible between the radiation source and the detector; this prevents an excessive amount of particles to be absorbed before they impinge on the detector. However, the field coil is advantageously wound on a hollow carrier; this simplifies both production and handling.

In a particularly advantageous embodiment of the invention, the coil is wound on a hollow carrier, the surface of which is a subset of a surface that is symmetrical with respect to the longitudinal axis of the sample space. This implies that the shape of the carrier continuously changes along the longitudinal axis of the sample space. The carrier is composed of at least one section, but can also be composed of a plurality of sections. The latter design enables transversal access to the interior of the sample space, for example.

The surface can notably be a rotational solid about the longitudinal axis of the sample space. The carrier is then rotationally symmetrical and can thus be produced easily and with high precision by means of material machining. Subsequently, the field coil can be wound thereon particularly easily mechanically, given the rotational symmetry. In a particularly advantageous embodiment of the invention, the diameter of the carrier can increase strictly monotonically along at least 10%, preferably at least 20%, and particularly preferably at least 30% of the longitudinal axis of the sample space and it can decrease strictly monotonically along at least 10%, preferably at least 20%, and particularly preferably at least 30% of the longitudinal axis of the sample space, so as to further improve the uniformity of the field.

In a further advantageous embodiment of the invention, the means for generating the magnetic field comprise at least one separately actuatable correction coil. If the field coil is wound on a carrier, this correction coil can notably be disposed thereon. This further increases the uniformity of the magnetic field in the sample space. Correction coils and the configuration of the field coil advantageously complement each other, particularly when the correction coils are used for rough correction of the uniformity and the configuration of the field coil is used for fine-tuning. As described above, the effect of the correction coils on the magnetic field distribution is dependent on the positions and current intensities with great sensitivity. The exclusive use of correction coils is disadvantageous. However, if the configuration of the field coil is available as an adjustment tool, this circumstance can be turned into an advantage: the high, yet difficult-to-control transconductance the correction coils is used to bring a large deviation of the magnetic field distribution in the sample space from perfect uniformity into a region in which it can be handled for the further optimization by means of a change in the configuration of the field coil that has a lesser effect but can be controlled more precisely. The pre-correction by the correction coils does not have the inherent risk of worsening, rather than improving, the uniformity due to a minor mispositioning of the correction coils. Depending on the application, the tolerance for positioning the correction coils can be increased by a factor of up to 1000, as compared to the prior art.

The advantages of such interplay between the field coil and correction coils are caused physically by the contribution of a region conducting a particular current to the magnetic field at a particular point in the sample space being continuously dependent on the distance between the region and the point, and by this distance being continuously variable. This is exactly what happens with the configuration of the field coil according to the invention. To this end, a local change in the turn diameter of the field coil generally has considerably less effect than a change in the current through one of few discrete correction coils.

The field coil advantageously comprises at least two layers of turns that are wound on top of one another. This advantageously increases the total number of turns decisive for the magnetic flux, which can be accommodated on a particular coil length.

In a particularly advantageous embodiment of the invention, the device comprises a power lead that is able to supply the collectivity of all field coils. Consequently, only two electrical lines must lead into the device, instead of a multiple lines for additional correction coils. The maximum number of electrical lines is subject to limitations in many applications, for example when using the device in a cryostat. With a particular number of lines, the device according to the invention achieves better uniformity of the field in the sample space than according to the prior art.

For example, it is possible to use a single field coil, which is continuously wound on a carrier having the configuration according to the invention.

Moreover, within the scope of the invention, a method for optimizing one or more predefined properties of the magnetic field generated by a device in an oblong sample space was developed. The predefined property of the magnetic field can be not only the uniformity, for example, but also the absolute or relative strength of a direction component.

The method is based on the assumption that the device comprises at least one field coil that is continuously wound around the sample space and that a set of free optimization parameters, on which the magnetic field in the sample space depends, is predefined. Furthermore, additional conditions may be predefined. These additional conditions can be, for example, the total size of the device, the size and the line cross-section of the field coil, the desired field intensity, the desired uniformity, and the size and shape of the region in which this field intensity and uniformity are desired (volume of interest, VOI).

According to the invention, first the magnetic field distribution in the sample space is determined from the particular values of the optimization parameters. Subsequently, the value of a quality function, which is dependent on the property or properties of the magnetic field to be optimized, is determined for this determined magnetic field distribution. In a particularly advantageous embodiment of the invention, the quality function depends on a norm of the uniformity of the magnetic field in the sample space.

New values of the optimization parameters, which satisfy potentially predefined additional conditions, are determined based on the quality function and from the particular values of the optimization parameters. “Based on” in this context shall mean that the quality function in the parameter space can be evaluated, allowing conclusions regarding the course thereof.

The aforementioned steps are repeated using the newly gained values of the optimization parameters until a predefined termination condition is reached. Suitable termination conditions are, for example, when a predefined threshold for the value of the quality function is reached or when a predefined number of repetitions (iterations) is reached, and arbitrary combinations of these conditions. The values of the optimizations parameters that are ultimately obtained can then be used as specifications for producing the device.

It was found that, when carrying out this method, the property that is to be optimized, for example, in a particularly advantageous embodiment, the uniformity of the magnetic field, can be included in the quality function, and consequently in the determination of the optimal values of the optimization parameters, in a larger partial volume of the sample space than when conducting optimization methods according to the prior art. In this way, it is also possible to optimize the device so that it has a smaller size, with the same quality in relation to the property to be optimized, or so that it has a larger useful volume (volume of interest, VOI) having a particular quality with respect to the property to be optimized at the same size.

The optimization methods according to the prior art were based on series expansion of the local magnetic field around a particular point in the sample space. The free parameters of the device (positions and currents of the correction coils) were determined by setting the errors of certain orders of this series expansion to zero and thereby solving the resulting system of equations. The partial volume of the sample space in which uniformity of the magnetic field was achieved using these prior art methods was limited by the fact that the series expansion was valid only in a limited partial volume around the particular point and quickly became imprecise as the distance from this point increased. The optimization method according to the invention is no longer dependent on the analytical representation by approximation of the relationship between the optimization parameters and the magnetic field in the sample space. The optimization method is therefore not flawed by the problem that such an analytical representation is an approximation that is only valid in a very narrow partial volume of the sample space.

In general, any numerical optimization method can be employed to determine new values of the optimization parameters from the existing values of the optimization parameters and the value of the power function. It has proven to be particularly advantageous to use a descent method, and here notably a gradient method. Such a method progresses successively in the direction of the negative gradient of the quality function and in this way finds values for the optimization parameters at which the quality function at least assumes a local minimum. Additional step size control may also be used, for example “Armijo's step size rule”.

In a particularly advantageous embodiment of the invention, the optimization parameters are selected so that at least one field coil is optimized with respect to the varying turn diameter along the longitudinal axis of the sample space. The course obtained at the end of the optimization can then be used, for example, as a model for the mechanical production of a carrier on which the field coil is then mechanically wound.

Advantageously, the course of the turn diameter is approximated by splines or described by another parameterized formulation. In this way, the required optimal function course is expressed by a discrete set of free optimization parameters, which is easier to handle for optimization algorithms. Because of the sectional definition, splines have an advantage over globally explained polynomials in that, for many functions, considerably better approximation can be achieved. In this way, higher-order splines can also be used to simulate more complicated functions with only few extremes. In the approximation of more complicated functions by global interpolation polynomials of a higher degree, the approximation function oscillates to an undesirable extent. It is also possible to employ Bezier curves as approximation functions.

In a particularly advantageous embodiment of the invention, the position and/or the size of at least one additional correction coil are selected as further optimization parameters. The optimization of the uniformity of the magnetic field in the sample space can then advantageously be divided among the position and/or size of the correction coil on the one hand, and the configuration of the field coil on the other. A correction coil can be used, for example, to achieve a predefined uniformity with less deviation of the configuration of the field coil from the solenoid form. Because additional construction volume is to be expected with a deviation from the solenoid form, the uniformity that is achievable with a particular construction volume can be improved.

This additionally creates a synergetic effect in that optimizing the configuration reduces the sensitivity of the magnetic field in the sample space with respect to small changes in the positions and/or sizes of correction coils. Optimizing these positions and sizes therefore becomes easier with respect to the handling by the optimization algorithm and, additionally, the obtained optimum is stable against inaccuracies in the material-related implementation. According to the prior art, which only employed correction coils, the optimum was so unstable that it was no longer possible at times to achieve the required precision for the positioning of the correction coils within the scope of the mechanical manufacturing tolerances.

The quality function can be a measure of the integral over a norm of the uniformity of the magnetic field in a partial volume of the sample space, wherein the norm can relate to the relative uniformity ΔB/B or to the absolute uniformity in units of the magnetic field. The integral can be approximated, for example, by the quality function containing the sum of, for example weighted, norms of the local (relative or absolute) uniformities of the magnetic field over a discrete number of points in the sample space. This discrete number of points can be disposed, for example, in a grid.

The norm that is selected can be, for example, the Euclidian norm or the maximum norm of uniformity.

The method can be used in particular for producing devices according to the invention. Devices according to the invention, and devices having a magnetic field that has been optimized in accordance with the invention, can be used to continuously polarize solid-state targets in particle acceleration. For this application, it is necessary to simultaneously satisfy requirements that vary from each other and are contradictory for the magnet design in terms of intensity and uniformity of the magnetic field, size of the magnet, and the lowest number of power leads possible. Magnetic resonance imaging (MRI) can also benefit from devices according to the invention and devices having a magnetic field optimized in accordance with the invention.

### SPECIFIC DESCRIPTION

Below, the subject matter of the invention will be described in more detail based on figures, without thereby limiting the subject matter of the invention. In the figures:

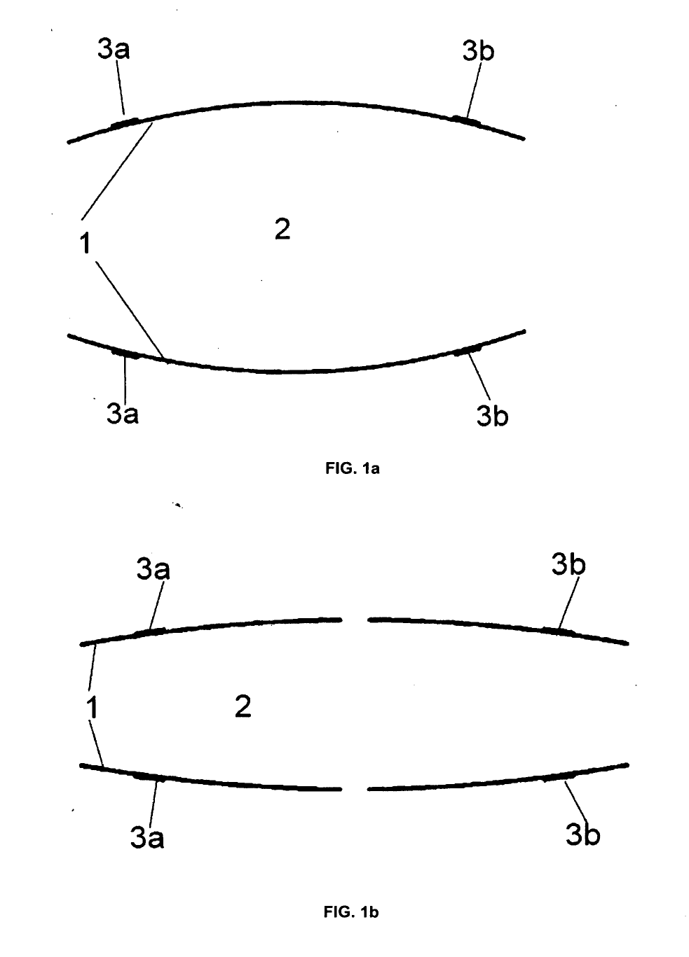

FIG. 1: shows cross-sections of embodiments of the device according to the invention comprising a single-piece carrier (partial image a) and a two-piece carrier (partial image b).

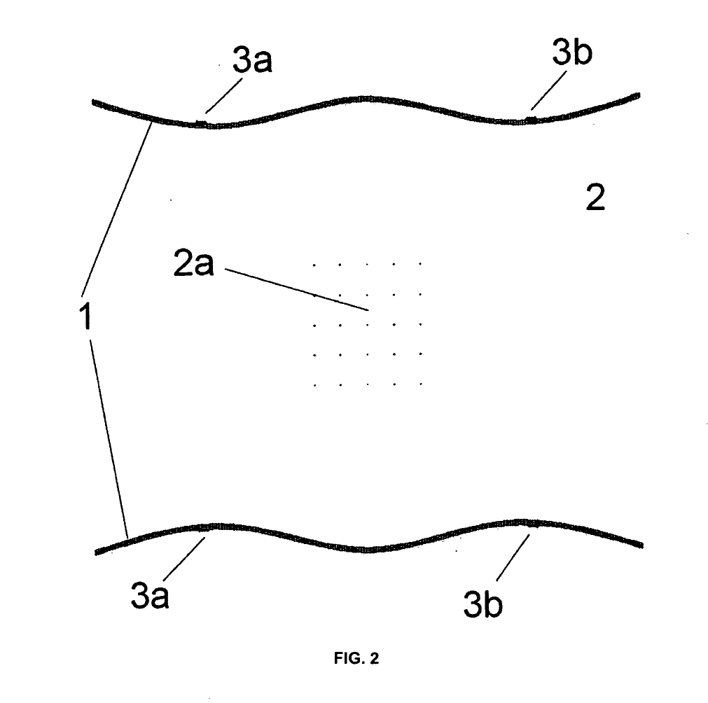

FIG. 2: shows a cross-section of a further embodiment of the device according to the invention.

FIG. 1a shows a cross-section of an embodiment of the device according to the invention. The carrier 1, which surrounds the oblong sample space 2, is symmetrical with respect to the longitudinal axis of this sample space, and the diameter thereof has a local maximum at the center of this longitudinal axis. In this way, the turn diameter in the field coil increases strictly monotonically along 50% of the longitudinal axis of the sample space, and it decreases strictly monotonically along 50% of the longitudinal axis of the sample space. The turns of the field coil, which are continuously wound on the carrier, are not shown here. Correction coils 3a and 3b are disposed on the carrier 1 to pre-correct the magnetic field in the sample space. FIG. 1b shows a cross-section of another embodiment of the device according to the invention. Here, the carrier 1 is composed of two parts 1a and 1b. A field coil is wound on each of these parts 1a and 1b. A gap (opening) is present between the parts 1a and 1b, through which the interior of the sample space 2 is transversally accessible even during operation of the device. The turn diameter increases strictly monotonically along almost half the longitudinal axis of the sample space, and it decreases strictly monotonically along almost half of the longitudinal axis of the sample space, over the total length of the field coils wound on the parts 1a and 1b. The two coils are electrically connected in series. In this way, the device has one power lead that is able to supply the collectivity of all field coils.

FIG. 2 shows a cross-section of another embodiment of the device according to the invention. In addition to a local maximum, the diameter of the carrier 1, which surrounds the oblong sample space 2, also has two local minima. The correction coils 3a and 3b are disposed on the carrier in the vicinity of these minima. The partial volume 2a having the best uniformity of the magnetic field is shown in the sample space 2. This partial volume can be utilized notably for magnetic resonance examinations as the “volume of interest” (VOI).

1. A device for generating a uniform magnetic field in an oblong sample space, comprising at least one field coil for generating the magnetic field, the field coil being continuously wound around the sample space, and the turn diameter thereof continuously changing in at least a portion of the field coil along a longitudinal axis of the sample space.

2. The device according to claim 1, wherein the field coil, or in the collectivity of all field coils, the turn diameter increases strictly monotonically along at least 10% of the longitudinal axis of the sample space and it decreases strictly monotonically along at least 10% of the longitudinal axis of the sample space.

3. The device according to claim 1, wherein the field coil is wound on a hollow carrier, the surface of which is a subset of a surface that is symmetrical with respect to the longitudinal axis of the sample space.

4. A device according to claim 1, wherein the means for generating the magnetic field comprises at least one separately actuatable correction coil.

5. A device according to claim 1, wherein the field coil comprises at least two layers of turns that are wound on top of one another.

6. A device according to claim 1 comprising a power lead that is able to supply the collectivity of all field coils.

7. A method for optimizing one or more predefined properties of the magnetic field generated by a device in an oblong sample space, the device comprising at least one field coil that is continuously wound around the sample space, with a set of free optimization parameters being specified, on which the magnetic field in the sample space depends, and optionally with a set of additional conditions being specified, comprising the following steps:
determining the magnetic field distribution in the sample space from the particular values of the optimization parameters;
determining the value of a quality function, which is dependent on the property or properties to be optimized, for this magnetic field distribution;
determining new values of the optimization parameters, which satisfy potentially predefined additional conditions, from the particular values of the optimization parameters and based on the quality function;
repeating the said steps using the new values of the optimization parameters until a predefined termination condition is reached.

8. The method according to claim 7, wherein the quality function depends on a norm of the uniformity of the magnetic field in the sample space.

9. The method according to, claim 7, wherein reaching of a predefined threshold value for the value of the quality function is selected as a termination condition.

10. A method according to claim 7, wherein reaching of a predefined number of iterations is selected as a termination condition.

11. A method according to claim 7, wherein the optimization parameters are selected so that at least one field coil is optimized with respect to the varying turn diameter along the longitudinal axis of the sample space.

12. The method according to claim 11, wherein the course of the turn diameter is approximated by splines or described by a parameterized formulation.

13. The method according to claim 11, wherein the position and/or the size of at least one additional correction coil are selected as further optimization parameters.

14. A method according to claim 7, wherein the quality function contains the sum of norms of the local relative uniformities of the magnetic field over a discrete number of points in the sample space.

15. The method according to claim 14, wherein the Euclidian norm of the uniformity is selected.

16. The method according to claim 14, wherein the maximum norm of the uniformity is selected.

17. The device according to claim 2, wherein the field coil is wound on a hollow carrier, the surface of which is a subset of a surface that is symmetrical with respect to the longitudinal axis of the sample space.

18. A device according to claim 2, wherein the means for generating the magnetic field comprises at least one separately actuatable correction coil.

19. A device according to claim 3, wherein the means for generating the magnetic field comprises at least one separately actuatable correction coil.

20. A device according to claim 2, wherein the field coil comprises at least two layers of turns that are wound on top of one another.
